(19) United States
(12) Patent Application Publication
(10) Pub. No.: US 2009/0276154 A1
(43) Pub. Date: Nov. 5, 2009

(54) METHOD AND SYSTEM FOR COORDINATING GROUP TRAVEL AMONG MOBILE DEVICES

(75) Inventors: Sankar SUBRAMANIAN, Ossining, NY (US); James C. FLOWERS, Rutherford, NJ (US); Joseph FRAGALE, Ridgewood, NJ (US); Douglas E. SAMUELS, Pound Ridge, NY (US)

Correspondence Address: VERIZON;PATENT MANAGEMENT GROUP, 1320 North Court House Road, 9th Floor, ARLINGTON, VA, 22201-2909, US

(73) Assignee: VERIZON CORPORATE SERVICES GROUP INC., Basking Ridge, NJ (US)

(21) Appl. No.: 12/112,239

(22) Filed: Apr. 30, 2008

(51) Int. Cl. G01C 21/28

(52) U.S. Cl. 701/213

(57) ABSTRACT

An approach is provided for coordinating travel. A plurality of mobile devices is identified as a group, wherein each of the mobile devices is configured to obtain location information. A lead mobile device is designated among the group. Routing information or information about a common destination, specified by the lead mobile device, is transmitted to other mobile devices in the group.

### BACKGROUND INFORMATION

A growing number of users rely on Global Positioning System (GPS) devices for travel and navigation. These devices, however, have been designed primarily for use by single users and have limited support for coordinating group travel. When users find the need to travel in groups, they must communicate their travel destinations and routes between members of the group in either verbal or written form, and then manually enter the destinations into their GPS devices. This process is labor-intensive, error-prone and cumbersome for users. Often times, the user would have to enter the destination into the GPS device as a full street address because the device may not list the desired destination as a “point-of-interest.” At other times, a destination may not be known in advance or may not be easily designated (e.g., picnic spot that is not on a marked street). Group members also may want to travel to the same destination along the same route, but differences in routing preferences and algorithms used in different GPS devices make calculating the same route difficult. In the absence of better coordination and communication among the GPS devices of group members, group travel presents significant problems.

In parallel, communications service providers are continually challenged to develop new services and features to remain competitive and to develop new sources of revenue.

Therefore, there is a need for an approach that provides convenient and accurate techniques for coordinating the travel of a group of mobile location-aware devices, while creating a new source of revenue for communication service providers.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing coordination of travel among a group of mobile devices, according to an exemplary embodiment;

FIG. 2 is a diagram of a mobile device including a group travel coordinator, according to an exemplary embodiment;

FIG. 3 is a diagram of an exemplary process for coordinating group travel from a lead mobile device, according to an exemplary embodiment;

FIG. 4 is a flowchart of a process for coordinating group travel, according to an exemplary embodiment;

FIGS. 5A-5D are flowcharts of processes for determining routes and destinations, according to various exemplary embodiments;

FIG. 6 is a flowchart of a process for logging routing information and/or destination information as a mobile device travels, according to an exemplary embodiment;

FIG. 7 is a flowchart of a process for downloading previously created routing information and/or destination information to a mobile device, according to an exemplary embodiment; and

FIG. 8 is a diagram of a computer system that can be used to implement various exemplary embodiments.

### DESCRIPTION OF THE PREFERRED EMBODIMENT

A preferred apparatus, method, and system for coordinating the travel of a group of mobile devices are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although the various exemplary embodiments are described with respect to Global Positioning System (GPS) technology, it is contemplated that the various exemplary embodiments are also applicable to other equivalent navigational and location determination technologies.

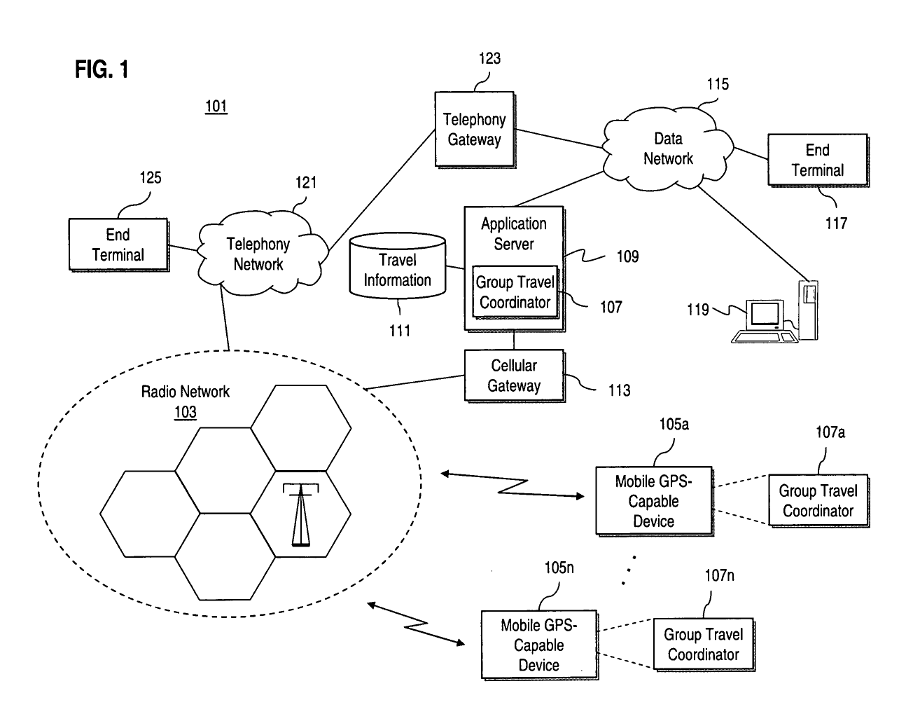

FIG. 1 is a diagram of a communication system capable of coordinating the travel of a group of mobile devices, according to an exemplary embodiment. For the purposes of illustration, a mechanism for coordinating the travel of a group of mobile devices is described with respect to a communication system 100 that includes a radio network 103, such as a cellular network. It is contemplated that the network may employ various technologies including, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

One or more mobile devices 105a-105n utilize group travel coordinators 107a-107n, which can reside locally within the respective mobile devices 105a-105n for coordinating communication of routing information and/or destination information (e.g., addresses, points of interests (POIs), position information, etc.). In addition (or alternatively), the group travel coordinator 107 can reside on the network side—e.g., within an application server 109. In this manner, travel of a group of mobile devices can be either networked-coordinated or coordinated by the mobile device 105.

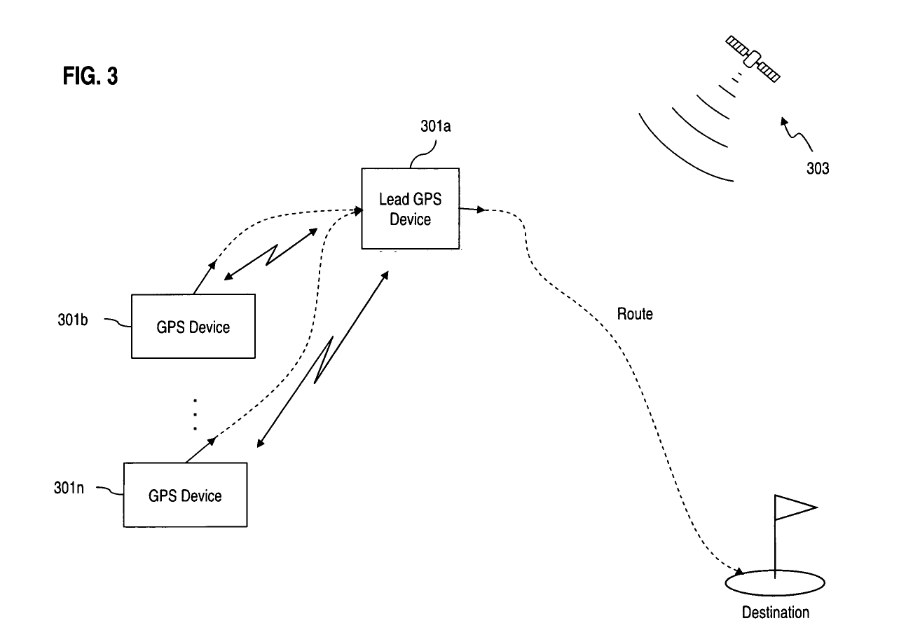

Using the group travel coordinator 107a, mobile device 105a can form or join with a group of mobile devices (e.g., mobile device 105n) for communicating travel routing information and/or destination information. Such sharing of travel information is automated, thereby allowing the user to enjoy the ease-of-use of the location capabilities of the mobile device without the burden of manually entering or updating the group's travel goals. This approach, which is more fully described below with respect to FIGS. 3-7, also enables the user and other group members to synchronize routes and monitor the progress of other group members during the route.

Traditionally, GPS devices do not provide functions to facilitate traveling in groups. As a result, each user traveling in a group must manually enter the group's common destination into the user's GPS device which creates the potential for destination entry errors. As earlier discussed, this process also can be laborious and cumbersome, discouraging users from using the device. In many cases, the group's destination may not be easily entered into the device (e.g., destination is located in an unmarked section of the navigation map) or the destination may not be known at the beginning of the route (e.g., group members want to meet at some mutually convenient common location without regard to the exact location). In addition, unexpected events (e.g., detours due to closed roads or construction, heavy traffic, etc.) may cause group members to lose contact with other members and make it difficult for the group to assemble at the final destination, particularly when the final destination is not precisely defined on navigation maps (e.g., large parking lots, campuses). The group travel coordinator 107 addresses these problems by relieving group members of manually entering routing information and/or destination information, and by handling the coordination of routing among group members.

The group travel coordinator 107 also provides a logging capability, whereby a user can log routing information and/or destination information for downloading and use at a later time. The recorded route may include additional location-aware components such as audio or video commentary designed to trigger at specific locations. This routing option removes the restriction that group members must travel at the same time. Instead, a user may travel the same route as other group members at any time. For example, members of an automobile club may create scenic routes for later use. Group members may then download and replay the routes and accompanying information (e.g., commentary on landmarks or points of interest) at their leisure.

As seen in FIG. 1, the application server 109 has access to a database 111 of group travel information and routes, which can be downloaded by the mobile device 105 via application server 109 and a cellular gateway 113. The application server 109 also has connectivity to a data network 115 that supports an end terminal 117. The end terminal 117 can be any computing device that provides access to application server 109 and group travel coordinator 107. Under one scenario, it is contemplated that a user can access group travel information for the mobile device 105 through the end terminal 117.

The data network 115 additionally permits a host 119 to modify group travel information via a graphical user interface (GUI) such as a browser application or any web-based application for the mobile device 105. Data network 115 may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. It is contemplated that the user of the mobile device 105 can input and update the group's travel information through a web browser or through the mobile device 105 itself. Alternatively, the host 119 can run applications to configure the group's travel information.

The data network 115 communicates with a telephony network 121 using a telephony gateway 123. In this example, the telephony network 121 can provide access from the end terminal 125 to the application server 109 and group travel coordinator 107.

Although the group travel coordination function is described with respect to the mobile device 105, it is recognized that the group travel coordination function can be applied to any device capable of accessing the application server 109 and group travel coordinator 107—e.g., end terminals 117, 125 and host 119.

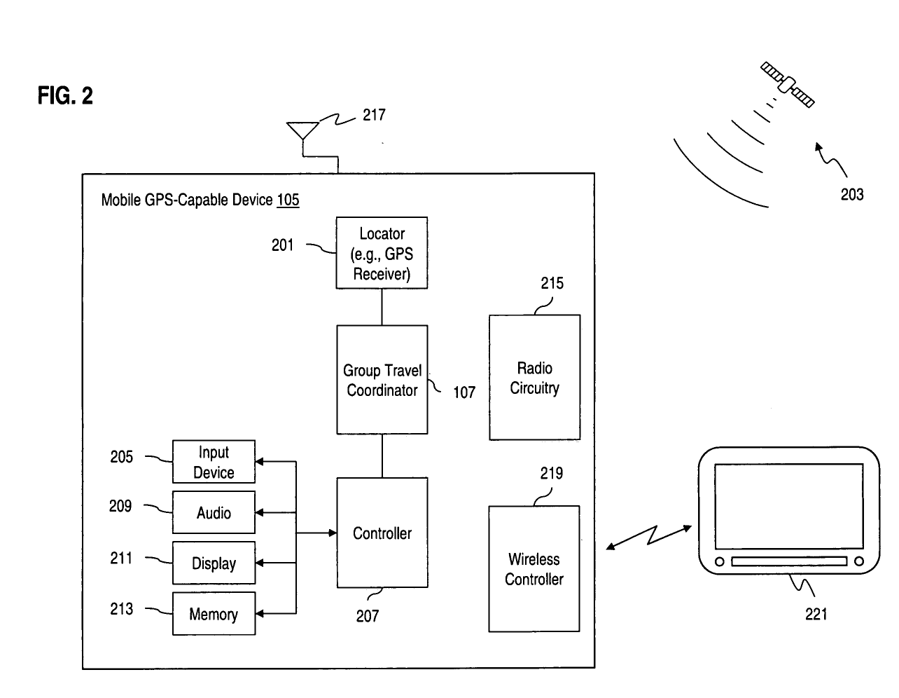

FIG. 2 is a diagram of a mobile device 105 including a group travel coordinator 107, according to an exemplary embodiment. In this embodiment, the mobile device 105 includes a locator 201 to determine the location of the mobile device 105. By way of example, the locator 201 includes a GPS receiver that receives position data from multiple GPS satellites 203. These GPS satellites 203 transmit very low power interference and jamming resistant signals. At any point on Earth, the locator 201 can receive signals from multiple satellites. Specifically, locator 201 may determine three-dimensional geolocation (or spatial positioning information) from signals obtained from, for instance, at least four satellites. Measurements from satellite tracking and monitoring stations located around the world are incorporated into orbital models for each satellite to compute precise orbital or clock data. GPS signals are transmitted over two spread spectrum microwave carrier signals that are shared by GPS satellites 203. Mobile device 105 needs to identify the signals from at least four satellites 203, decode the ephemeris and clock data, determine the pseudo range for each satellite 203, and compute the position of the receiving antenna. With GPS technology, mobile device 105 can determine its spatial position with great accuracy and convenience. As noted above, it is contemplated that the various exemplary embodiments are also applicable to other equivalent navigational and location determination technologies. The position data is utilized by the group travel coordinator 107 to provide navigation instructions according to the group's travel goals and routing preferences.

In addition (or alternatively), the mobile device 105 can be equipped with a wireless controller 219 to communicate with an external GPS device 221 for acquisition of position data. The external GPS device can employ any number of standard radio technologies to communicate with the wireless controller 219; for example, the external GPS device can use short range radio transmission technology, such as BLUETOOTH. It is contemplated that other equivalent short range radio technology and protocols can be utilized. It also is contemplated that the external GPS device may be a compatible stand-alone device, automobile navigation system, or other equivalent system.

A controller 207 is provided to control functions of an input device 205 (e.g., keyboard, touch screen, or other input mechanism), an audio function circuitry 209, a display unit 211, and a memory 213. A user can enter group travel information using the input device 205. The audio function circuitry 209 provides audio cues to the user to support of various applications and mobile device functions. Similarly, the display unit 211 provides a display to the user in support of various applications and mobile device functions. The memory 213 can store routing information and parameters, travel destinations, identities of the group members, locations of group members, and other variables for use by the group travel coordinator 107.

The group travel coordinator 107, in one embodiment, in conjunction with the controller 207 designates appropriate group travel routing on the mobile device 105 according to the group travel goals and selected options. Travel goal, options, and parameters are stored in memory 213 and include starting location of group members, desired destination, method of routing, and group progress through the route.

In addition, the mobile device 105 employs radio circuitry 215 to communicate over the radio network 103 (of FIG. 1) using radio frequency (RF) signaling. The radio circuitry 215 can be defined in terms of front-end and back-end characteristics. The front-end of the receiver encompasses all of the RF circuitry whereas the back-end encompasses all of the base-band processing circuitry. For further explanation and background, voice signals transmitted to the mobile device 105 are received via antenna 217 and immediately amplified by a low noise amplifier (LNA) (not shown). A down-converter lowers the carrier frequency while the demodulation strips away the RF leaving only a digital bit stream. The signal then goes through the equalizer and is processed by a Digital Signal Processor (DSP) (not shown). The DSP may, depending upon the implementation, perform any of a variety of conventional digital processing functions on the voice signals. Additionally, the DSP determines the background noise level of the local environment from the signals detected by the microphone (part of the audio function circuitry 209) and sets the gain of the microphone to a level selected to compensate for the natural tendency of the user of the mobile device. A Digital-to-Analog Converter (DAC) (not shown) converts the signal and resulting output is transmitted to the user through a speaker in the audio function circuitry 209, as controlled by the controller 207.

In use, a user speaks into a microphone and his or her voice, along with any detected background noise, is converted into an analog voltage. The analog voltage is then converted into a digital signal through the Analog-to-Digital Converter (ADC) (not shown). The controller 207 routes the digital signal into the DSP for processing therein, such as speech encoding, channel encoding, encrypting, and interleaving. The encoded signals are then routed to an equalizer for compensation of any frequency-dependent impairments that occur during transmission though the air such as phase and amplitude distortion. After equalizing the bit stream, a modulator (not shown) combines the signal with a RF signal generated in the RF interface. The modulator generates a sine wave by way of frequency or phase modulation, for example. In order to prepare the signal for transmission, an up-converter (not shown) combines the sine wave output from the modulator with another sine wave generated by a synthesizer (not shown) to achieve the desired frequency of transmission. The signal is then sent through a Power Amplifier (PA) (not shown) to increase the signal to an appropriate power level. In practical systems, the PA acts as a variable gain amplifier whose gain is controlled by the DSP from information received from a network base station. The signal is then filtered within the duplexer and optionally sent to an antenna coupler to match impedances to provide maximum power transfer. Finally, the signal is transmitted via antenna to a local base station. An automatic gain control (AGC) (not shown) can be supplied to control the gain of the final stages of the radio circuitry 215. The signals may be forwarded from there to a remote telephone which may be another cellular telephone, other mobile phone or a landline connected to a Public Switched Telephone Network (PSTN), or other telephony network 121 (of FIG. 1).

The operation of the group travel coordinator 107 is now described in FIGS. 3 through 7.

FIG. 3 is a diagram of an exemplary process for coordinating group travel from a lead mobile device. Under this scenario, mobile devices 301a-301n form into a group to travel to a common destination using a common route. The creation of the group can be, in an exemplary embodiment, a registration process performed in advance. Alternatively, the group can be form dynamically (or on-the-fly) based on proximity of the mobile devices 301a-301n or a predetermined criteria. By way of example, the mobile devices 301a to 301n are configured according to the specifications for mobile device 105 discussed above with respect to FIG. 2.

In this example, the group designates a lead mobile device 301a, and the lead user inputs the group's common destination into the lead mobile device 301a. In one embodiment, the first mobile device that designates itself as the leader can serve as the lead. Alternatively, the mobile device that is closest to the destination can be deemed the lead. Next, the lead mobile device 301a determines its position relative to GPS satellites 303, determines a route, and transmits the group's common destination and designated route to all non-lead mobile devices 301b-301n over a private and secure radio communications network. Transmission of routing information and/or destination information may occur through any means available on the communications network including, but not limited to, text messaging, electronic mail, instant messaging, and web browser link; such messages are then provided to an appropriate interface to the GPS application within the mobile devices 301b-301n

The group begins navigating along the designated route, and each member (e.g., devices 301a-301n) transmits its position to other members of the group at various intervals. Group members 301a-301n have the option to view the position of other group members 301a-301n on their respective devices. The group leader 301a has the additional option of being alerted if any member deviates from the designated route. If a group member deviates from the designated route, the member's mobile device will reroute back to the designated route. The route is completed when the last group member reaches the common destination.

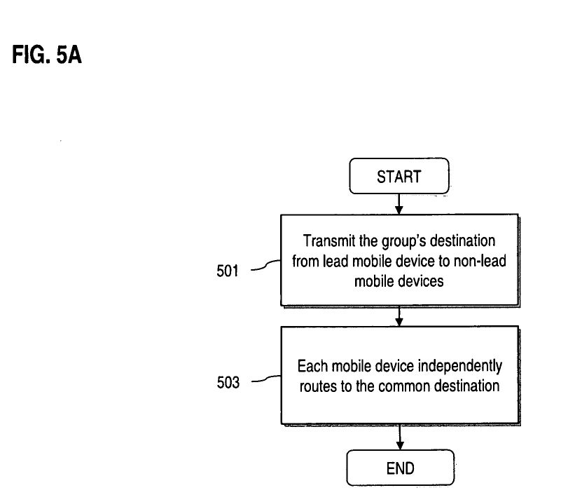

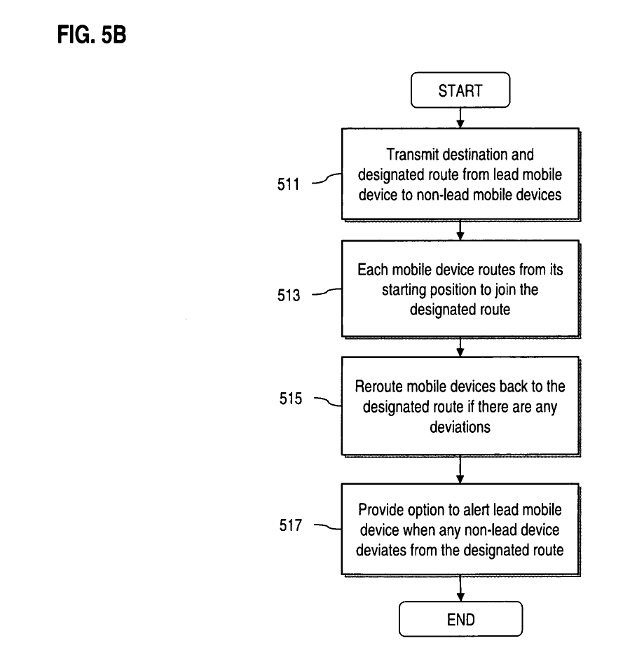

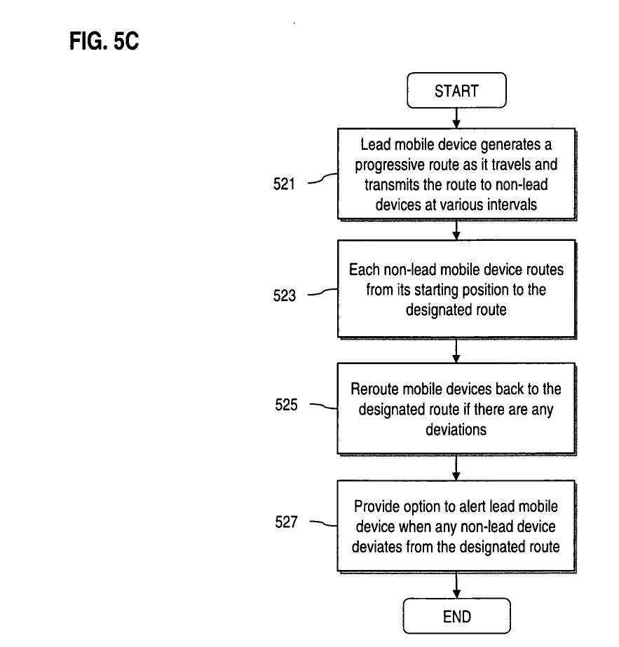

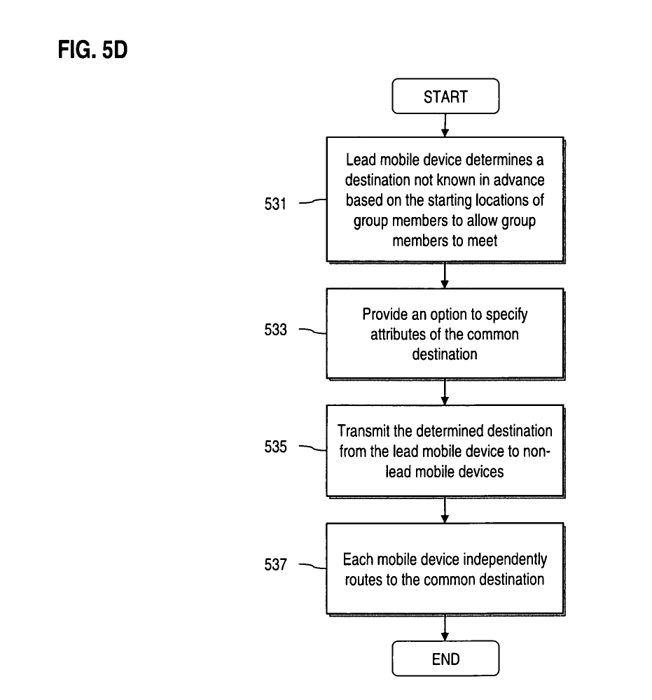

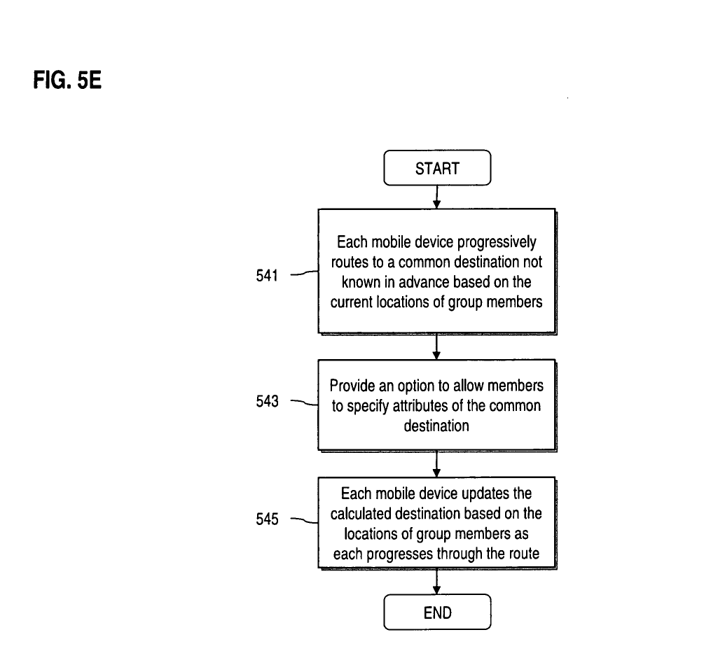

Other routing options, as described in FIGS. 5-7, (e.g., common destination with independent routing, progressive route generated by lead mobile device, etc.) also are contemplated. These processes are described with respect to the system of FIG. 3.

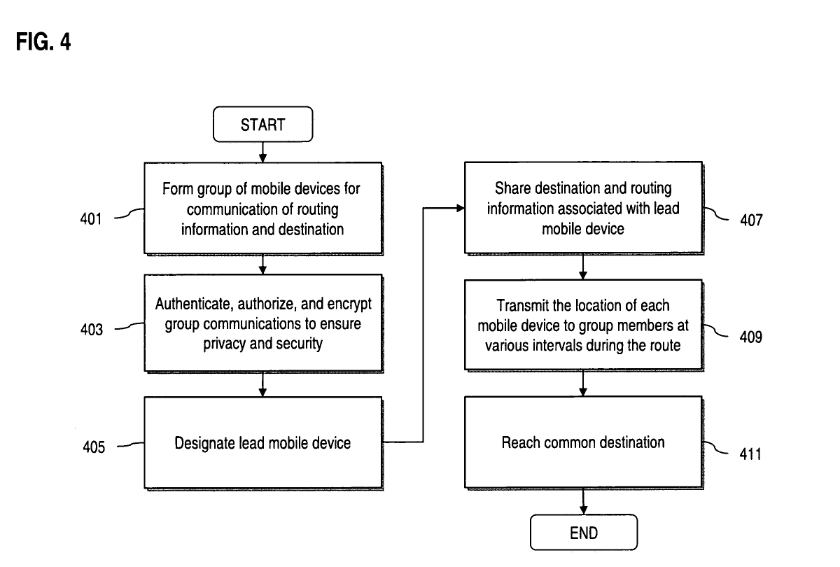

FIG. 4 is a flowchart of a process for coordinating group travel, according to an exemplary embodiment. It is noted that the steps of process described in FIG. 4 may be performed in any suitable order or combined in any suitable manner.

In step 401, a group of mobile devices 301b-301n, which are configured to obtain location information, may be formed for transmission of routing information and information about a common destination. According to particular embodiments, the group may include mobile devices 301b-301n mounted on a motor vehicle (e.g., automobile, motorcycle, truck, etc.), an individual, or any other suitable mobile platform. It also is contemplated that a user may belong to more than one group and that a group may include any number of members and may exist for any duration (e.g., for one trip only or indefinitely). Additionally, a group can be formed manually or through automated means.

In step 403, communication links among group members are authenticated, authorized, and encrypted to ensure that communication of routing and destination information are private and secure. Privacy and security are important because group members may be sharing potentially sensitive information such as group destination, preferred routes, member locations, and member identities. As mentioned above, communication of routing information and/or destination information may occur through any means available on the communications network including, but not limited to, text messaging, electronic mail, instant messaging, and web browser link.

Per step 405, the group designates a lead mobile device 301 a. The lead mobile device 301a may be selected by various means including, for example, voting by group members, appointment, or by other criteria such as vehicle location, GPS capabilities, etc. Each mobile device is configured to have the capability to designate a leader by one or more means. Under certain exemplary group routing options (e.g., routing processes described in FIGS. 5A-5D), the lead mobile device 301a will be responsible for designating a common destination and/or generating a route for non-lead devices to follow. Further, in some routing options (e.g., routing process described in FIG. 5E), a lead mobile device is not required. As appropriate, the lead mobile device 301a will select a destination and routing options and transmit the information to non-lead devices 301b-301n, per step 407. Exemplary embodiments of these routing options are described in more detail with reference to FIGS. 5A-5E below.

As an option, the lead mobile device 301a may be notified when group members 301b-301n deviate from the designated route or common destination. This alert may be an audio and/or video alert. Further, the lead mobile device 301a, as well as other mobile devices 301b-301n in the group, may be configured to depict the current locations of group members on its map display. Updated location information is transmitted from each mobile device 301a-301n to other members of the group at various intervals, per step 409. These location updates allow group members to monitor the progress and locations of other members. It is contemplated that the intervals of these updates may be set by the group to occur a specific time intervals (e.g., every 30 seconds), by each mobile device 301a-301n according to specific parameters (e.g., transmit location when reaching specific waypoints such as turns, or transmit location when deviating from the route), or by a combination of approaches. Group mobile devices 301a-301n continue to transmit their locations until reaching the common destination in step 411.

FIGS. 5A-5E are flowcharts depicting exemplary embodiments of group routing options. It is noted that the steps of the processes described in FIGS. 5A-5E may be performed in any suitable order or combined in any suitable manner. It is contemplated that each of the routing options may be performed with group mobile devices starting at the same location or dispersed at different starting locations. The mobile devices 301a-301n within the group need not be at or near the same starting location.

FIG. 5A is a flowchart of a process for routing a group to a common destination with independent routing by each mobile device in the group, according to an exemplary embodiment. Under this option, the user enters the group's common destination into the lead mobile device 301a. Per step 501, the lead mobile device 301a then transmits the group's common destination to the non-lead mobile devices 301b-301n in the group. The transmission of the common destination ensures that all mobile devices 301a-301n with the group have the same destination entry. After receiving the transmission, each mobile device 301a-301n independently routes from its starting location to the common destination per step 503.

FIG. 5B is a flowchart of a process for routing a group to a common destination along a common route, according to an exemplary embodiment. Under this scenario, the user enters the group's common destination into the lead mobile device 301a. The lead mobile device 301a then determines a common route for the group to travel. Per step 511, the lead mobile device 301a transmits the common destination and designated route to the non-lead mobile devices 301b-301n in the group. After receiving the transmission, each mobile device 301b-301n routes from its starting position to join the designated route per step 513. Once the mobile device 301b-301n joins the route, the device 301b-301n will follow the designated route to the destination. If a mobile device 301b-301n deviates from the route, the device 301b-301n will reroute back to the designated route rather than the destination per step 515. The lead mobile device 301a also has the option to be alerted should any member deviate from the route per step 517.

FIG. 5C is a flowchart of a process for coordinating group travel using a progressive route generated by a lead mobile device, according to an exemplary embodiment. Under this option, the user does not enter a common destination into the lead mobile device 301a. Instead, the lead mobile device 301a generates a progressive route as it travels, per step 521. As the lead mobile device 301a travels, the device 301a will transmit its route at various intervals to the non-lead mobile devices 301b-301n. Each transmission will provide additional segments of the route until the lead mobile device 301a reaches the group's destination. The transmission intervals may be set manually at specific time intervals or automatically according to criteria for vehicle speed, road conditions, etc. After receiving the initial transmission, each mobile device 301b-301n routes from its starting position to join the designated route, per step 523. Once the mobile device joins the route, it will continue to receive transmissions of additional route segments and will follow the designated route to the destination. If a mobile device deviates from the route, the device will reroute back to the designated route rather than the destination per step 525. The lead mobile device 301a also has the option to be alerted should any member deviate from the route per step 527.

FIG. 5D is a flowchart of a process for coordinating group travel to a common destination not known in advance that is determined by a lead mobile device, according to an exemplary embodiment. Under this option, group members would like to meet at a common location not known in advance. In step 531, the lead mobile device 301a determines a destination based on the starting locations of each member that will allow members to meet. The group may specify one or more attributes of the desired destination (e.g., restaurant, shopping center, movie theater, street name, etc.) to direct calculation of the common destination per step 533. The lead mobile device 301a then transmits the group's common destination to non-lead mobile devices 301b-301n per step 535. The transmission of the common destination ensures that all mobile devices with the group have the same destination entry. After receiving the transmission, each mobile device independently routes from its starting location to the common destination per step 537.

FIG. 5E is a flowchart of a process for coordinating group travel to a common destination not known in advance determined dynamically by each group member, according to an exemplary embodiment. Under this option, group members 301a-301n would like to meet at a common location not known in advance. However, unlike the option discussed above, there is no lead mobile device, and each mobile device within the group progressively determines a route that will allow members to meet per step 541. Each mobile device 301a-301n begins by calculating a destination that will allow members to meet at a common destination based on the starting location of each member. The group also may specify one or more attributes of the desired destination (e.g., restaurant, shopping center, movie theater, street name, etc.) to direct calculation of the common destination per step 543. As each mobile device travels along its route, the mobile device recalculates the common destination based on the current locations of other group members per 545.

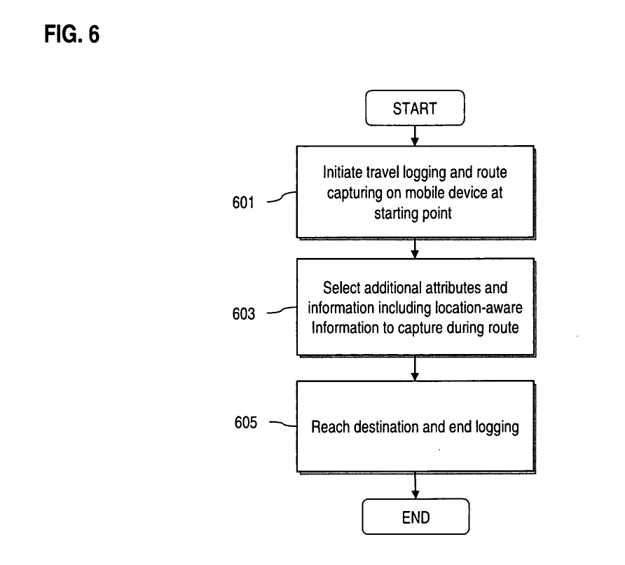

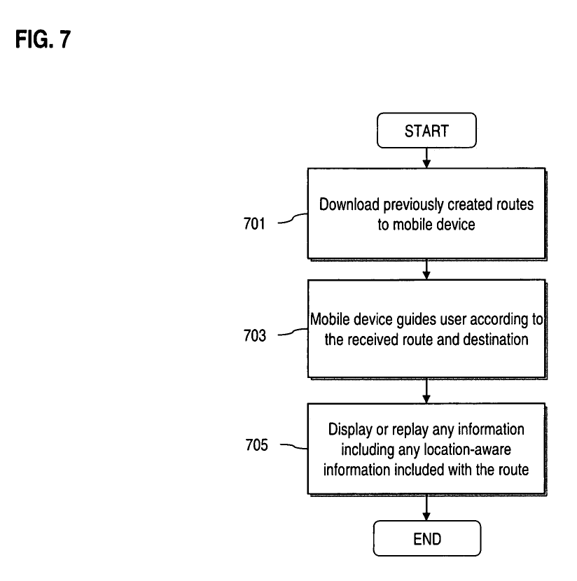

FIGS. 6 and 7 are flowcharts, respectively, of a process for logging routing information and/or destination information as a mobile device travels, and of a process for downloading previously created routing information and/or destination information to a mobile device, according to exemplary embodiments. It is noted that the steps of the processes described in FIGS. 6 and 7 may be performed in any suitable order or combined in any suitable manner.

The travel logging process described in FIG. 6 begins when the user initiates travel logging on the mobile device at a route's starting point per step 601. The user has the option to capture additional attributes of the route including velocity, stops, tour information, voice comments, video, etc. (step 603). Logging ends when the mobile device reaches its destination per step 605. It is contemplated that the mobile device may capture the optional additional attributes and associate them with location information so that the user will have the capability to create a “guided tour” of the route. In this way, the recorded route may include multi-media location-aware information that can be replayed at the appropriate locations along the route. The route may be captured directly to memory in the mobile device or to the application platform on the network.

FIG. 7 depicts a process for downloading previously created travel logs to a mobile device. In step 701, the user downloads previously created travel logs to the mobile device. It is contemplated that the user may download travel logs from a variety of sources, including other mobile devices, Internet sites, and the network application server. Once downloaded, the mobile will guide the user along the received route to the specified destination per step 703. During the route, the mobile device 301a-301n will display or replay any information included with the route per step 705. If the information is location-aware, the mobile device will provide the information when the user reaches the appropriate location.

The processes described herein for providing travel coordination processes may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

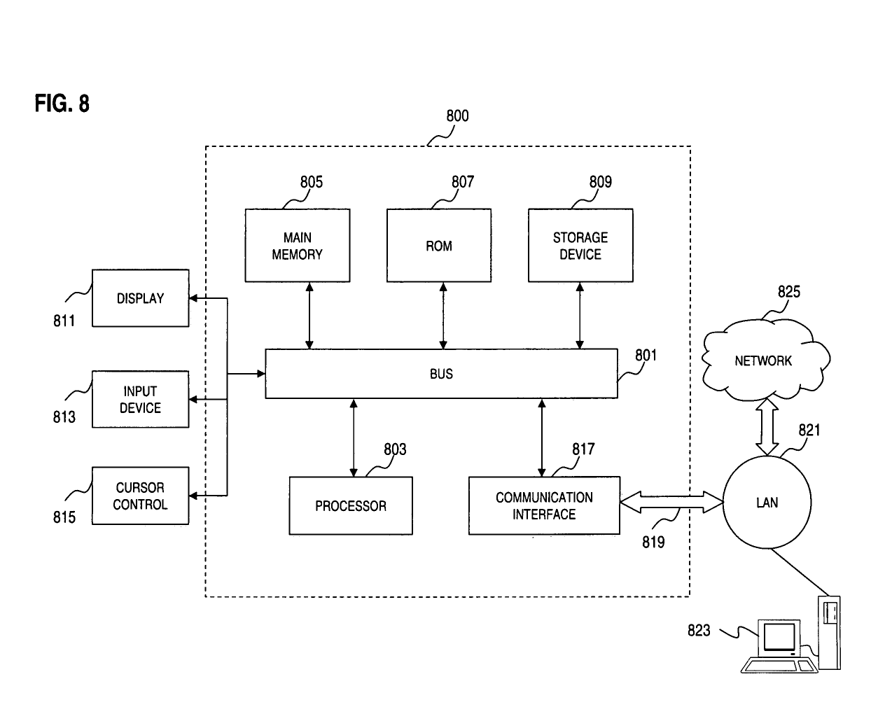

FIG. 8 illustrates computing hardware (e.g., computer system) upon which an embodiment according to the invention can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
identifying a plurality of mobile devices as a group, wherein each of the mobile devices is configured to obtain location information; and
transmitting routing information or information about a common destination to the mobile devices in the group.

2. A method according to claim 1, further comprising:
designating a lead mobile device among the group, wherein the common destination is specified by the lead mobile device.

3. A method according to claim 2, wherein the common destination information is transmitted by the lead mobile device to the other mobile devices.

4. A method according to claim 2, further comprising:
notifying the lead mobile device about location of the other mobile devices.

5. A method according to claim 2, wherein the routing information is transmitted intermittently to the other mobile devices as the lead mobile devices progresses along a route associated with the routing information or the common destination information.

6. A method according to claim 5, wherein the lead mobile device is alerted if anyone of the other mobile devices deviates from the route.

7. A method according to claim 1, further comprising:
establishing secure communications among the group for the transmission of the routing information or the common destination information.

8. A method according to claim 1, wherein each of the mobile devices is further configured to utilize a Global Positioning System (GPS) to obtain the location information relating to the routing information or the common destination information.

9. A method according to claim 1, wherein each of the mobile devices is further configured to independently route to the common destination.

10. A method according to claim 1, wherein the common destination information is transmitted to the mobile devices as an electronic mail or an instant communication message.

11. A method according to claim 1, further comprising: logging one or more attributes relating to a route to the common destination.

12. An apparatus comprising:
a processor configured to identify a plurality of mobile devices as a group, wherein each of the mobile devices is configured to obtain location information; and
a communication interface configured to transmit routing information or information about a common destination to other mobile devices in the group.

13. An apparatus according to claim 12, wherein the processor is further configured to designate a lead mobile device among the group, wherein the common destination is specified by the lead mobile device.

14. An apparatus according to claim 13, wherein the common destination information is transmitted by the lead mobile device to the other mobile devices.

15. An apparatus according to claim 13, wherein the lead mobile device is notified about location of the other mobile devices.

16. An apparatus according to claim 13, wherein the routing information is transmitted intermittently to the other mobile devices as the lead mobile devices progresses along a route associated with the routing information or the common destination information.

17. An apparatus according to claim 16, wherein the lead mobile device is alerted if anyone of the other mobile devices deviates from the route.

18. An apparatus according to claim 12, wherein the transmission of the routing information or the common destination information is over a secure communications channel.

19. An apparatus according to claim 12, wherein each of the mobile devices is further configured to utilize a Global Positioning System (GPS) to obtain the location information relating to the routing information or the common destination information.

20. An apparatus according to claim 12, wherein each of the mobile devices is further configured to independently route to the common destination.

21. An apparatus according to claim 12, wherein the common destination information is transmitted to the mobile devices as an electronic mail or an instant communication message.

22. An apparatus according to claim 12, further comprising:
a database configured to log one or more attributes relating to a route to the common destination.

23. A system comprising:
a gateway configured to communicate over a wireless network that serves a plurality of mobile devices; and
an application server coupled to the gateway and configured to identify the plurality of the mobile devices as a group seeking to reach a common destination or follow a common route, the application server being further configured to designate a lead mobile device among the group,
wherein information about the common route or information about the common destination is transmitted to the mobile devices over the wireless network, each of the mobile devices being configured to obtain location information relating to the common route or the common destination.

24. A system according to claim 23, wherein each of the mobile devices is further configured to utilize a Global Positioning System (GPS) to generate the location information.
